(19) United States
(12) Patent Application Publication
(10) Pub. No.: US 2007/0279808 A1
(43) Pub. Date: Dec. 6, 2007

(54) Sensing mechanism for reading magnetic storage medium

(76) Inventors: Icko E.T. Iben, Santa Clara, CA (US); Larry L. Tretter, Tucson, AZ (US)

Correspondence Address: LAW OFFICES OF MICHAEL DRYJA, 1474 N COOPER RD #105-248, GILBERT, AZ, 85233, US

(21) Appl. No.: 11/443,570

(22) Filed: May 31, 2006

(51) Int. Cl. G11B 5/33; G11B 5/127

(52) U.S. Cl. 360/313

(57) ABSTRACT

A sensing mechanism for reading a magnetic storage medium includes first and second variable resistive elements, and sensing elements. Each first and second variable resistive element has a variable resistance. Each sensing element has a resistance depending at least on a portion of the medium currently being read. First and second ends of each sensing element are electrically connected to corresponding first and second variable resistive elements, respectively. For each sensing element, the resistance value of the first variable resistive element to which it is electrically connected is equal to the resistance of the second variable resistive element to which it is electrically connected, so that a mid-point voltage at each sensing element is equal. For each sensing element, the variable resistances of the first and second variable resistive elements to which it is electrically connected are selected so that the desired current flows through the sensing element.

### FIELD OF THE INVENTION

The present invention relates generally to a sensing mechanism for reading a magnetic storage medium, like a magnetic tape used to store data, and more particularly to such a sensing mechanism in which the mid-point voltages of sensing elements of the sensing mechanism are kept equal.

### BACKGROUND OF THE INVENTION

Tape drives are popular ways to back up data. In a typical tape drive, a magnetic storage tape cartridge is inserted into the tape drive. The tape drive has a read/write head to write data to the tape as it moves across the head during write operations, and also to read data from the tape as it moves across the head during both read and write operations. The read/write head works by magnetizing the tape during write operations, and by reading the magnetic polarity transition of the tape during read operations.

For the read operations in particular, the read/write head of a tape drive has a sensing mechanism having a number of sensing elements. The tape is moved past the sensing elements, and the sensing elements detect transitions in the magnetic polarity of the tape as it moves past the read head. The sensing elements are typically magneto-resistive elements, where the resistance of a given sensing element varies depending on the magnitude and orientation of the magnetization of the sensing elements. For magnetic storage devices, the sensor magnetization of the sensing elements is altered by the magnetic signals emanating from the storage media, such as the tapes or disks.

Each sensing element of the sensing mechanism can have a different applied, or bias, current for optimum sensitivity of the sensing element to the magnetic polarity of the tape. Each sensing element may have its own current or voltage supply that is independent of the current or voltage supplies powering the other sensing elements. Biasing the sensing elements differently is needed because the sensing elements may have different inherent optimum bias points. For example, manufacturing tolerances for magneto-resistive sensing elements are such that their resistances vary by as much as a factor of two within a single product line. Furthermore, such differences require a wide range of bias currents between parts, even within a single read/write head having multiple sensing elements.

Biasing the sensing elements of the sensing mechanism differently, however, means that the sensing elements may be at different voltages with respect to one another, and with respect to other parts of the air-bearing surface (ABS), which is the surface of a sensing element past which a magnetic medium moves for sensing by the element. These differences in voltages can cause electrochemical-plating effects, and other electrochemical effects, between the tape and components of the sensing elements. For example, electrochemical-plating effects include the transfer of metallic particles from the tape onto the sensing mechanism. These particles can build up on the sensing elements, and ultimately electrically bridge different components of the sensing elements together, impeding their ability to read the magnetic signals from the tape.

The electrochemical effects, such as plating effects, can be exacerbated by voltage differences between the sensing elements and the surrounding materials, such as the tape or the substrate in which the sensing elements are embedded, as well as metal shields and poles of the sensing element, which is also known as a read/write head. It is known that intentional plating of metals onto a substrate is accomplished by setting the voltage of the substrate at a fixed differential value relative to the bath in which the metals are dissolved. Plating of materials from the tape onto a read/write head is similarly accomplished, although undesirably and detrimentally. This plating may be minimized by setting all components at the same voltage. Traditional current biasing schemes use the same nominal bias resistance for all the sensing elements, and vary the bias current through each sensing element. The result is thus that each sensing element is at a different relative voltage from a fixed ground, causing the undesirable electrochemical plating.

Therefore, there is a need within the prior art to prevent such electrochemical-plating effects and other electrochemical effects between the tape and the sensing elements of the sensing mechanism, while still retaining the ability to independently vary the bias currents for the individual sensing elements. More particularly, there is a need to have the sensing elements at the same voltage with respect to one another. For these and other reasons, there is a need for the present invention.

### SUMMARY OF THE INVENTION

The present invention relates to a sensing mechanism for reading a magnetic storage medium, such as a magnetic tape. A sensing mechanism of one embodiment includes first variable resistive elements, second variable resistive elements, and sensing elements. Each first and second variable resistive element has a variable resistance. Each sensing element has a resistance depending at least on the portion of the magnetic storage medium currently being read. A first end of each sensing element is electrically connected to a corresponding first variable resistive element, and a second end of each sensing element is electrically connected to a corresponding second variable resistive element.

For each sensing element, the variable resistance of the first variably resistive element to which the sensing element is electrically connected is equal to the variable resistance of the second variably resistive element to which the sensing element is electrically connected. As a result, a mid-point voltage at each sensing element is equal. Furthermore, for each sensing element, the variable resistances of the first and second variably resistive elements to which the sensing element is electrically connected are selected so that the desired current flows through the sensing element.

A storage device of one embodiment of the invention includes one or more motors to move a magnetic storage medium, and a sensing mechanism to read the magnetic storage medium as it is moved. The sensing mechanism includes sensing elements, variable resistive mechanisms, and a voltage source. Each sensing element has a resistance depending at least on the portion of the magnetic storage medium currently being read. Each variable resistive mechanism is electrically connected to the first and second ends of a corresponding sensing element to selectively vary a current flowing through the corresponding sensing element, while maintaining a mid-point voltage at the sensing element equal to that at each other sensing element.

A method of one embodiment of the invention includes setting a variable resistance of a first variable resistive element electrically connected to a first end of a sensing element of a sensing mechanism for reading a magnetic storage medium, based on the desired current to flow through the sensing mechanism. A variable resistance of a second variable resistive element electrically connected to a second end of the sensing element of the sensing element is set equal to the variable resistance of the first variable resistive element, to maintain a constant mid-point voltage at the sensing element. The method detects an alternating current (AC) resistance signal of the sensing element and determines a value stored in the magnetic storage medium based on the AC resistance signal detected.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a sensing mechanism for reading a magnetic storage element, according to an embodiment of the invention.

FIG. 2 is a diagram of a tape storage medium, in relation to which embodiments of the invention can be practiced.

FIG. 3 is a block diagram of a rudimentary mass storage device, according to an embodiment of the invention.

FIG. 4 is a diagram of a portion of the sensing mechanism of FIG. 1 in more detail, according to an embodiment of the invention.

FIG. 5 is a diagram of a sensing element that can be employed in relation to the sensing mechanism of FIGS. 1 and/or 4, according to an embodiment of the invention.

FIG. 6 is a flowchart of a method, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

### Overview

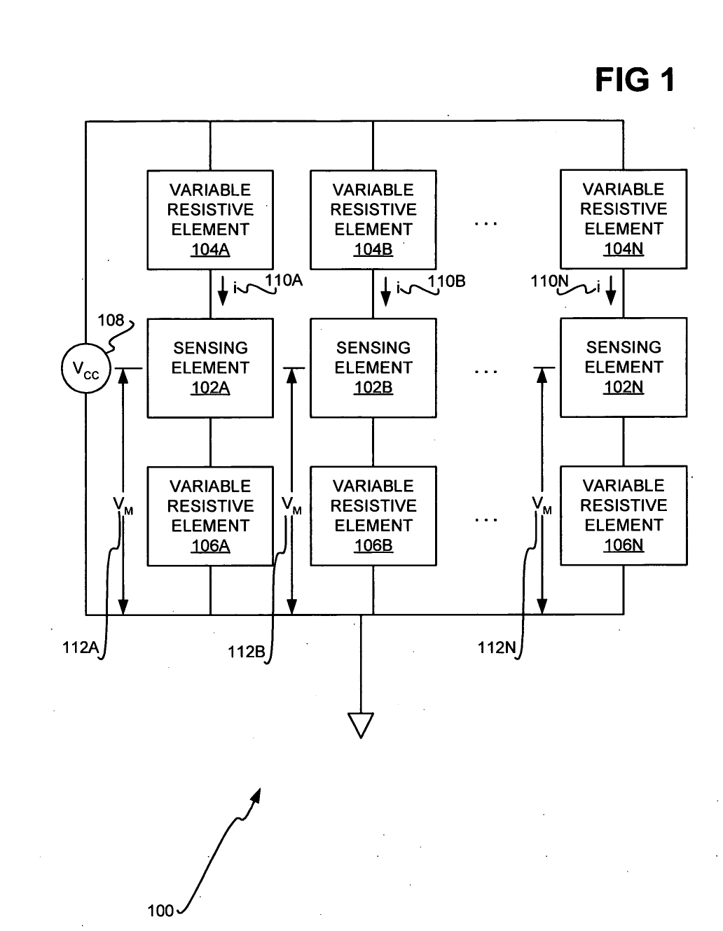

FIG. 1 shows a sensing mechanism 100 for reading a magnetic storage medium, such as a magnetic storage tape, according to an embodiment of the invention. The sensing mechanism 100 includes a number of sensing elements 102A, 102B, . . . , 102N, collectively referred to as the sensing elements 102. The sensing mechanism 100 also includes a first set of variable resistive elements 104A, 104B, . . . , 104N, collectively referred to as the variable resistive elements 104. The sensing mechanism 100 further includes a second set of variable resistive elements 106A, 106B, . . . , 106N, collectively referred to as the variable resistive elements 106. A voltage source 108 may be part of the sensing mechanism 100, or separate from the sensing mechanism 100. As can be appreciated by those of ordinary skill within the art, the sensing mechanism 100 may include additional components, besides those depicted in FIG. 1.

The sensing elements 102 detect the data stored on the portion of the magnetic storage medium over which the sensing elements 102 are currently incident. The sensing elements 102 may be thin-film sensors in one embodiment. Each of the sensing elements 102 has an inherent resistance, R_{seY}, which varies depending on the data on the current portion of the magnetic storage medium over which these sensors are currently located. That is, a transition in the magnetic polarity of the portion of the magnetic storage medium over which the sensor is currently located causes the resistance of each of the sensing elements 102 to vary. In this way, the sensing elements 102 can be used to read the data stored on the magnetic storage medium. The inherent resistance R_{seY} of each of the sensing elements 102 is nominally equal, but in actuality is different, due to manufacturing tolerances, local heating and other factors that affect these resistances. Thus, the resistance R_{seY}, where Y=1 . . . N, corresponding to the N sensing elements 102, are typically different for each sensing element Y. The resistances also may be different from one magnetic storage device to another, while the biasing circuitry within the sensing mechanism 100 (i.e., including the voltage source 108) is nominally identical due to the much higher tolerances achievable within the electronics industry.

To either end of the sensing elements 102 are electrically connected the variable resistive elements 104 and the variable resistive elements 106. The variable resistive elements 104 and 106 are together referred to as the variable resistive mechanisms. Thus, for the sensing element 102A, the variable resistive element 104A is electrically connected to one end of the sensing element 102A, one end of the variable resistive element 106A is electrically connected to the other end of the sensing element 102A, and the other end of the element 106A is connected to the ground of the voltage source 108, or to another offset voltage, which can be arbitrary. Thus, there exists a variable resistive mechanism that is electrically connected to the sensing element 102A that is made up of the elements 104A and 106A. Likewise, for the sensing element 102B, the variable resistive element 104B is electrically connected to one end of the sensing element 102B, and the variable resistive element 106B is electrically connected to the other end of the sensing element 102B, and so on.

The first variable resistive elements 104 each have a variable resistance value R_{1vrY}, and the second variable resistive elements 106 each have a variable resistance value R_{2vrY}, where Y=1 . . . N, corresponding to the N variable resistive elements 104 and the N variable resistive elements 106. The resistances R_{1vrY} and R_{2vrY} can be set independent of one another. Thus, the resistance R_{1vrY} for any first variable resistive element Y can be set differently than that for any other first variable resistive element Y. Likewise, the resistance R_{2vrY} for any second variable resistive element Y can be set differently than that for any other second variable resistive element Y. Similarly, the resistance R_{1vrY} for any first variable resistive element Y can be set differently than the resistance R_{2vrX} for any second variable resistive element X, where X may be equal to or different than Y. For a given element Y, the values of R_{1vrY} and R_{2vrY} are selected to be nominally equal.

There are currents 110A, 110B, . . . , 110N, collectively referred to as the currents 110, flowing through the sensing elements 102. For any given sensing element Y, the corresponding current i_{Y} flowing through the sensing element is equal to

$${i}_{Y} = \frac{{V}_{cc}}{{R}_{1 vrY} + {R}_{seY} + {R}_{2 vrY}} . \qquad ( 1 )$$

In equation (1), for the sensing element Y, R_{1vrY} is the resistance of the first variable resistive element Y that is electrically connected to one end of this sensing element, and R_{2vrY} is the resistance of the second variable resistive element Y that is electrically connected to the other end of this sensing element. The resistance R_{seY} is the resistance of the sensing element Y itself. The voltage V_{cc} is the voltage provided by the voltage source 108. The same voltage source 108 is connected to the sensing elements 102 as is depicted in FIG. 1. That is, there are N circuit branches connected in parallel to one another relative to the voltage source 108, where each parallel branch includes a first variable resistive element, a sensing element, and a second variable resistive element.

The current i_{Y} flowing through any given sensing element Y is varied so that it is the current corresponding to the optimum sensing capability of the sensing element relative to the magnetic storage medium in question. The manner by which the optimum current is determined is known by those of ordinary skill within the art. To vary the current i_{Y} flowing through any given sensing element Y so that it is the optimum, or desired, current, the variable resistances of the first variable resistive element Y connected to one end of the sensing element and of the second variable resistive element Y connected to the other end of the sensing element are set in accordance with equation (1) above. That is, because V_{cc} is known, and R_{seY} is known, the desired current i_{Y} can be specified by appropriately varying the variable resistances R_{1vrY} and R_{2vrY} of the first and second variable resistive elements Y in accordance with equation (1) above. The current i_{Y} flowing through any given sensing element Y is thus independent of the currents flowing through the other of the sensing elements 102.

Furthermore, there are mid-point voltages 112A, 112B, . . . , 112N, collectively referred to as the mid-point voltages 112, at the midpoints of the sensing elements 102. That is, the mid-point voltage at any given sensing element is the voltage measurable halfway between the ends of the sensing element, at the center of the sensing element in one embodiment. For any given sensing element Y, the corresponding mid-point voltage V_{mY} at the mid-point of this sensing element is equal to

$${V}_{mY} = {V}_{cc} ( \frac{\frac{{R}_{seY}}{2} + {R}_{2 vrY}}{{R}_{1 vrY} + {R}_{seY} + {R}_{2 vrY}} ) . \qquad ( 2 )$$

As in equation (1), in equation (2), for the sensing element Y, R_{1vrY} is the resistance of the first variable resistive element Y that is electrically connected to one end of this sensing element, and R_{2vrY} is the resistance of the second variable resistive element Y that is electrically connected to the other end of this sensing element. The resistance R_{seY} is the resistance of the sensing element Y itself. The voltage V_{cc} is the voltage provided by the voltage source 108.

To minimize, if not to completely eliminate, the electrochemical-plating effects, as well as other electrochemical effects, among the sensing elements 102, as described in the background section, the mid-point voltages 112 are desirably set so that they are equal to one another. That is, by having V_{mY} be the same value, regardless of the sensing element Y in question, embodiments of the invention substantially reduce or eliminate the electrochemical effects described in the background section, since there are then no absolute voltage differences among the sensing elements 102. Thus, the potential for the interaction between the sensing mechanism 100 and the magnetic storage medium being read by the sensing elements 102 to cause such electrochemical effects in relation to the sensing elements 102 is reduced.

Embodiments of the invention achieve maintenance of equal mid-point voltages 112, while still allowing the individual currents 110 to be independently varied, by setting R_{1vrY} equal to R_{2vrY} for any given sensing element Y. Therefore, the desired current i_{Y} for any given sensing element Y can be achieved by appropriately varying the variable resistances R_{1vrY} and R_{2vrY}. Stipulating an additional constraint, that R_{1vrY} is equal to R_{2vrY} for any given sensing element Y, further ensures that V_{mY} is the same for all the sensing elements 102.

This can be simply proven by setting R_{2vrY} equal to R_{1vrY} in equation (2) above. Making this substitution yields the following:

$${V}_{mY} = {V}_{cc} ( \frac{\frac{{R}_{seY}}{2} + {R}_{1 vrY}}{{R}_{1 vrY} + {R}_{seY} + {R}_{1 vrY}} ) = \frac{{V}_{cc}}{2} . \qquad ( 3 )$$

Therefore, so long as R_{2vrY} equals R_{1vrY}, for any given sensing element Y, V_{mY} is dependent only on V_{cc}, and not on any of the values of the resistances R_{seY}, and R_{1vrY}, As such, the desired current i_{Y} through any given sensing element Y can be achieved by varying the resistances R_{1vrY} and R_{2vrY} of the first and second variable resistive elements Y connected to this sensing element, while maintaining the same V_{mY} for all the sensing elements 102, so long as R_{1vrY} remains equal to R_{2vrY}.

It is noted that FIG. 1 is depicted such that there is a single power supply 108 for all of the sensing elements 102. However, in another embodiment, each sensing element may have its own power supply. Using a single power supply is advantageous because it removes variations in the supply voltage provided to each of the sensing elements 102. Therefore, where separate power supplies are employed for the sensing elements 102, their tolerance ranges should be sufficiently minimal to ensure that the same voltage is provided to each sensing element. Furthermore, in another embodiment, there may be fewer number of power supplies than sensing elements 102, where each power supply is connected to a subset of the sensing elements 102.

### TECHNICAL BACKGROUND

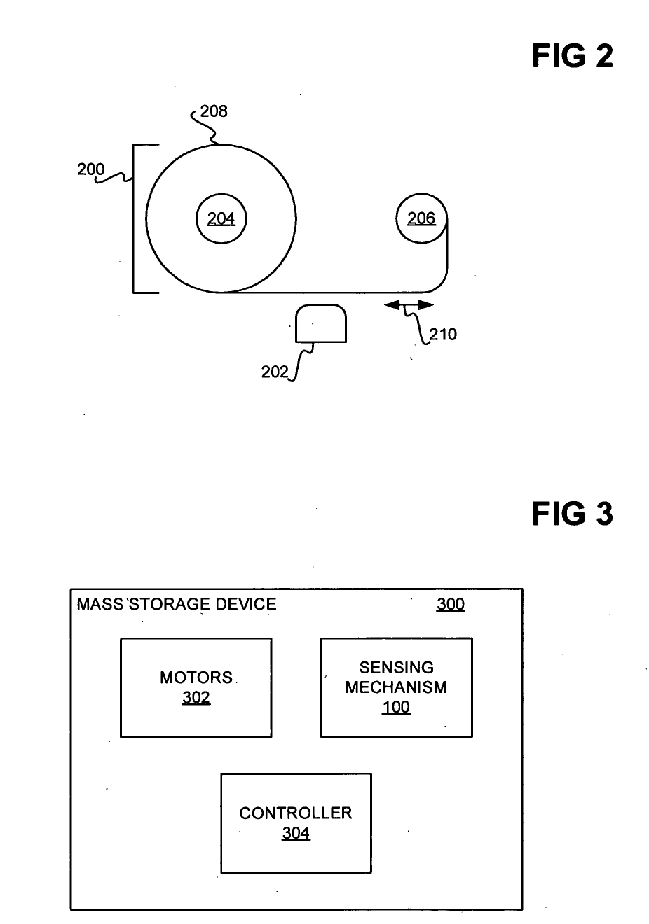

FIG. 2 shows a typical tape storage medium 200, in accordance with which embodiments of the invention may be practiced. There is a read/write head 202, on which the sensing mechanism 100 that has been described may be completely or partially disposed. The tape storage medium 200 itself includes a supply reel 204 on which a supply of magnetic tape 208 is wound. The medium 200 also includes a take-up reel 206. One or more motors engage the supply reel 204 and/or the take-up reel 206, so that the magnetic tape 208 can be moved past the read/write head 202. That is, the magnetic tape 208 is unwound from the supply reel 204, and wound onto the take-up reel 206. While the magnetic tape 208 moves past the read/write head 202, the head 202 is able to read the data stored on the magnetic tape 208. Thus, at any given time, the head 202 is able to read the data stored on the portion of the magnetic tape 208 to which it is currently incident. As can be appreciated by those of ordinary skill within the art, during actual usage of the tape storage medium 200, the tape 208 can move past the read/write head 202 in both a forward direction and a reverse direction, as indicated by the arrow 210.

FIG. 3 shows a rudimentary diagram of a mass storage device 300, according to an embodiment of the invention. The mass storage device 300 includes one or more motors 302, a sensing mechanism 100, and a controller 304. The motors 302 are for moving the magnetic storage medium, such as the magnetic tape 208 as has been described in relation to FIG. 2. The sensing mechanism 100 is for sensing the information that has been magnetically stored on the magnetic storage medium, and may be part of the read/write head 202 of FIG. 2. Among other tasks, the controller 304 operates the motors 302 and the sensing mechanism 100 to achieve read/write aspects of the device 300. The controller 304 may be implemented in software, hardware; or a combination of software and hardware.

While embodiments of the invention are substantially described herein in relation to a magnetic storage medium that is a magnetic tape cartridge, other embodiments are amenable to implementation in relation to other types of magnetic storage media, such as hard disk drives, and so on. Thus, in an embodiment in which the magnetic storage medium is a magnetic tape cartridge, the magnetic storage medium is removably insertable into the mass storage device 300, as can be appreciated by those of ordinary skill within the art. In an embodiment in which the magnetic storage medium is a hard disk drive, the magnetic storage medium is part of and fixed within the mass storage device 300, as can also be appreciated by those of ordinary skill within the art.

### DETAILED EMBODIMENT

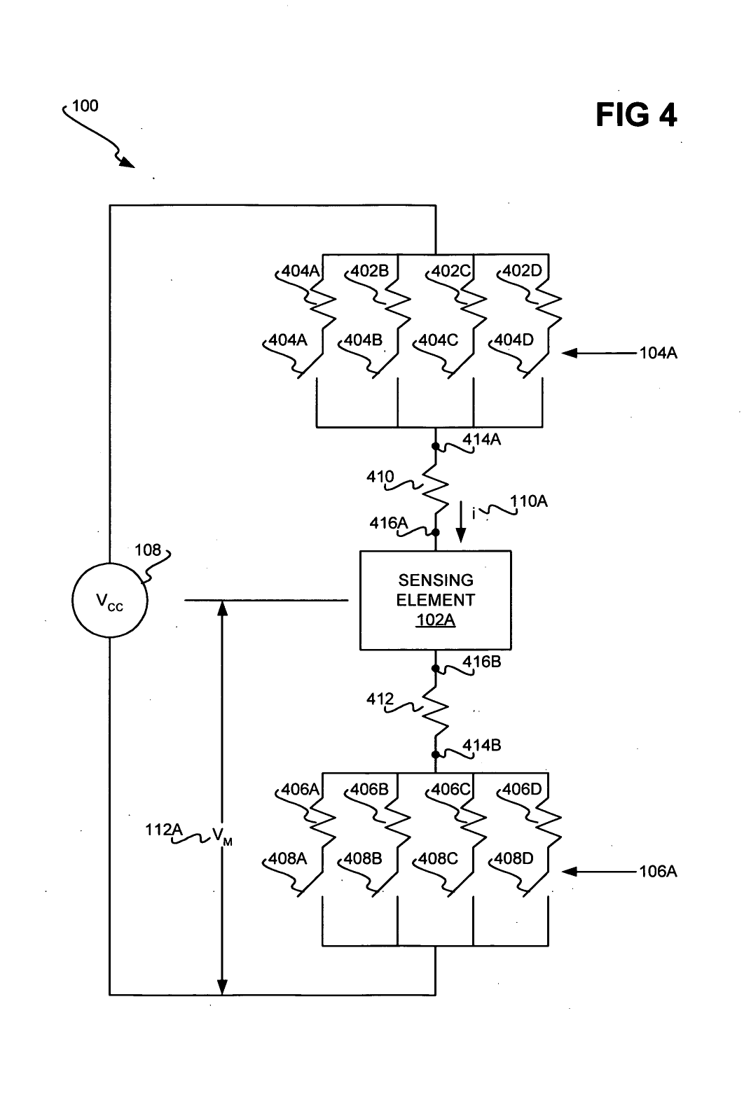

FIG. 4 shows the sensing mechanism 100 in more detail, according to an embodiment of the invention. For illustrative clarity and convenience, just one circuit branch of the mechanism 100 is depicted in FIG. 4. That is, just the branch including the sensing element 102A, the variable resistive element 104A, and the variable resistive element 106A is depicted in FIG. 4. This branch is representative of the other circuit branches of the mechanism 100, as has been described in relation to FIG. 1, and the description of this branch in relation to FIG. 4 herein is applicable to the other circuit branches of the mechanism 100 as well.

The variable resistive element 104A is shown in FIG. 4 as including a number of resistors 402A, 402B, 402C, and 402D, collectively referred to as the resistors 402, organized in parallel to one another, and having corresponding switches 404A, 404B, 404C, and 404D, collectively referred to as the switches 404. Four resistors 402 are depicted as an example only, and other embodiments may have more or less of the resistors 402. Each of the switches 404 controls whether a corresponding one of the resistors 402 is electrically connected. By selectively closing or opening different of the switches 404, a different variable resistance R₁ᵥᵣ₁ of the variable resistive element 104 as a whole can be achieved.

More particularly, the variable resistance R₁ᵥᵣ₁ of the variable resistive element 104 is equal to

$${R}_{1 vr 1} = \frac{1}{{S}_{1} \frac{1}{{R}_{1}} + {S}_{2} \frac{1}{{R}_{2}} + … + {S}_{M} \frac{1}{{R}_{M}}} . \qquad ( 4 )$$

In equation (4), R_{Y} is the resistance of a given of the resistors 402 referred to as the resistor Y, where there is a total of M of the resistors 402. Furthermore, S_{Y} is a binary variable that is equal to one when a given of the switches 404, referred to as the switch Y, is closed, and that is equal to zero when the switch is open. Therefore, for each resistor Y, the resistance R_{Y} of this resistor contributes to the total resistance R₁ᵥᵣ₁ if its corresponding switch Y is closed, such that S_{Y} is equal to one, and does not contribute to the total resistance R₁ᵥᵣ₁ if its corresponding switch Y is open, such that S_{Y} is equal to zero.

The variable resistive element 106A is also shown in FIG. 4 as including a number of resistors 406A, 406B, 406C, and 406D, collectively referred to as the resistors 406, electrically connected in parallel to one another, and having corresponding switches 408A, 408B, 408C, and 408D, collectively referred to as the switches 408. Each of the switches 408 controls whether a corresponding one of the resistors 406 is electrically connected. By selectively closing or opening different of the switches 404, a different variable resistance R₂ᵥᵣ₁ of the variable resistive element 106 as a whole can be achieved. When a switch is closed, it is said that the switch is in its on position, and when the switch is open, it is said that the switch is in its off position.

More particularly, the variable resistance R₂ᵥᵣ₁ of the variable resistive element 106 is similarly equal to

$${R}_{2 vr 1} = \frac{1}{{S}_{1} \frac{1}{{R}_{1}} + {S}_{2} \frac{1}{{R}_{2}} + … + {S}_{M} \frac{1}{{R}_{M}}} . \qquad ( 5 )$$

In equation (5), R_{Y} is the resistance of a given of the resistors 406 referred to as the resistor Y, where there is a total of M of the resistors 406. Furthermore, S_{Y} is a binary variable that is equal to one when a given of the switches 406, referred to as the switch Y, is closed, and that is equal to zero when the switch is open. Therefore, for each resistor Y, the resistance R_{Y} of this resistor contributes to the total resistance R₂ᵥᵣ₁ if its corresponding switch Y is closed, such that S_{Y} is equal to one, and does not contribute to the total resistance R₂ᵥᵣ₁ if its corresponding switch Y is open, such that S_{Y} is equal to zero. When a given resistor has its corresponding switch closed, it is said that the resistor has been switched on. Likewise, when a given resistor has its corresponding switch opened, it is said that the resistor has been switched off.

To ensure that R₁ᵥᵣ₁ is always equal to R₁ᵥᵣ₂, the resistors 402 of the variable resistive element 104A should be equal in number and correspond in value to the resistors 406 of the variable resistive element 106A. Thus, the resistance of the resistor 402A should be equal to the resistance of the resistor 406A, the resistance of the resistor 402B should be equal to the resistance of the resistor 406B, and so on. Furthermore, corresponding of the switches 404 and 408 should be both opened or both closed. Thus, if the switch 404A is open, then the switch 408A should be open, if the switch 404B is closed, then the switch 408B should also be closed, and so on.

In one embodiment, the sensing mechanism 100 in the embodiment of FIG. 4 also includes two constant resistive elements 410 and 412. The constant resistive element 410 has a constant resistance, and is electrically connected to one end of the sensing element 102A and to the first variable resistive element 104A. However, in this situation, it is still said herein that the variable resistive element 104A is electrically connected to the sensing element 102A. The constant resistive element 412 also has a constant resistance, equal to that of the constant resistive element 410, and is electrically connected to the other end of the sensing element 102A and to the second variable resistive element 106A. However, in this situation, it is still said herein that the variable resistive element 106A is electrically connected to the sensing element 102A.

In one embodiment, the variable resistive mechanism for the sensing element 102A is said to include the variable resistive elements 104A and 106A, and thus their constituent resistors 402 and 406 and switches 404 and 408, as well as the constant resistive elements 410 and 412. The resistors 402 and 406 of the variable resistive elements 104A and 106A, as well as the constant resistive elements 410 and 412, may be implemented as discrete resistors that are soldered or otherwise mounted onto a printed circuit board of the sensing mechanism 100. Alternatively, they may be thin-film resistors formed within an integrated circuit of the sensing mechanism 100. The switches 404 and 408 may be field-effect transistors (FET's), other types of transistors, or other types of switches completely.

The desired current 110A flowing through the sensing element 102A is controlled in the embodiment of FIG. 4 by selectively opening and closing the switches 404 to yield desired variable resistances of the variable resistive elements 104A and 106. Where the resistors 402 correspond in number and in value to the resistors 406, where the switches 404 are turned on in correspondence with the switches 408, and where the resistances of the constant resistive elements 410 and 412 are equal, the mid-point voltage 112A at the sensing element 102A is maintained at the voltage of the voltage source 108 divided by two, as has been described. That is, so long as the resistance of the variable resistive element 104A is equal to the resistance of the variable resistive element 106A, and where the resistances of the constant resistive elements 410 and 412 are equal to one another, the desired current 110A flowing through the sensing element 102A can be varied while maintaining the same mid-point voltage 112A, as has been described.

As can be appreciated by those of ordinary skill within the art, the sensing mechanism 100 of FIG. 4 may include various coupling points. For instance, there may be coupling points 414A and 414B, collectively referred to as the coupling points 414. The coupling points 414 may be connected to other portions of the sensing mechanism 100 via high-impedance direct current couplings, where these portions of the mechanism 100 may themselves have low electrical impedance within the operating frequency range of sensing mechanism 100. For example, the coupling points 414 may be capacitively coupled to the ground of the sensing element 102A.

As another example, there may be coupling points 416A and 416B, collectively referred to as the coupling points 416. The coupling points 416 may connect to detection circuitry of the sensing mechanism 100, which is not particularly shown in FIG. 4. Such connection may be through high-impedance direct current electrical elements, which have a low electrical impedance within the operating frequency range of the sensing mechanism 100. For example, the coupling points 416 may be capacitively coupled to the inputs of a differential amplifier.

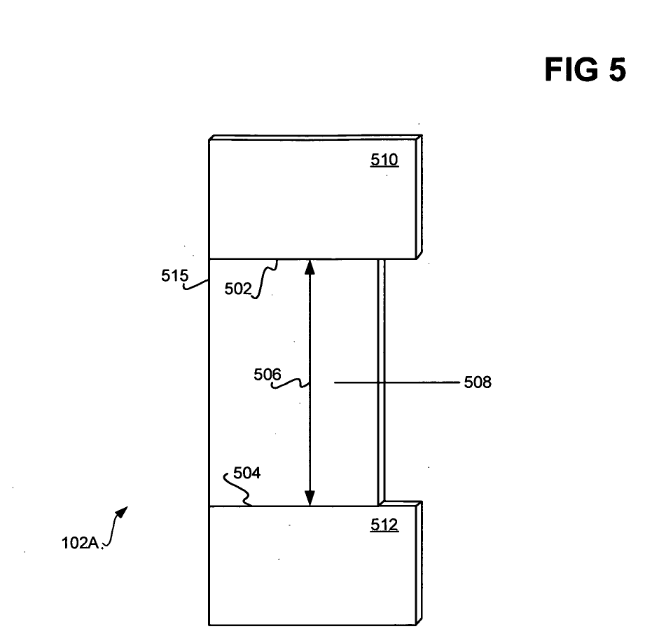

FIG. 5 shows the sensing element 102A in detail as exemplarily representative of all the sensing elements 102, according to an embodiment of the invention. The sensing element 102A in the embodiment of FIG. 5 is implemented as a thin-film sheet resistor. The sensing element 102A has a first end 502 to which the first variable resistive element 104A and the constant resistive element 410 are electrically connected, and a second end 504 to which the second variable resistive element 106A and the constant resistive element 412 are electrically connected. The resistive elements 104A and 106A themselves are not depicted in FIG. 5 for illustrative clarity.

The resistance of the sensing element 102A, Rₛₑₗ, is uniformly distributed over the length 506 of the sensing element 102A. This is why the mid-point voltage 112A at the mid-point 508 of the sensing element 102A is based on Rₛₑₗ divided by two in equation (3) above. Thus, from the end 504 to the mid-point 508 of the sensing element 102A, the resistance of the sensing element 102A is half of its total resistance, or Rₛₑₗ divided by two.

As depicted in FIG. 5, there may be a connective lead 510 connected to the end 502 of the sensing element 102A, and a connective lead 512 connected to the other end 504 of the sensing element 102A. The leads 510 and 512 may be metal. As such, the leads 510 and 512 themselves have low resistance values. The leads 510 and 512 connect to coupling points 416A and 416B, respectively of FIG. 4. The surface 515 opposite of these leads 510 and 512 is the air-bearing surface (ABS). The ABS is the surface of the sensing element 102A against which the magnetic medium is moved, so that the sensing element 102 is able to detect transitions, or changes, in magnetic polarity of the magnetic medium.

### Method

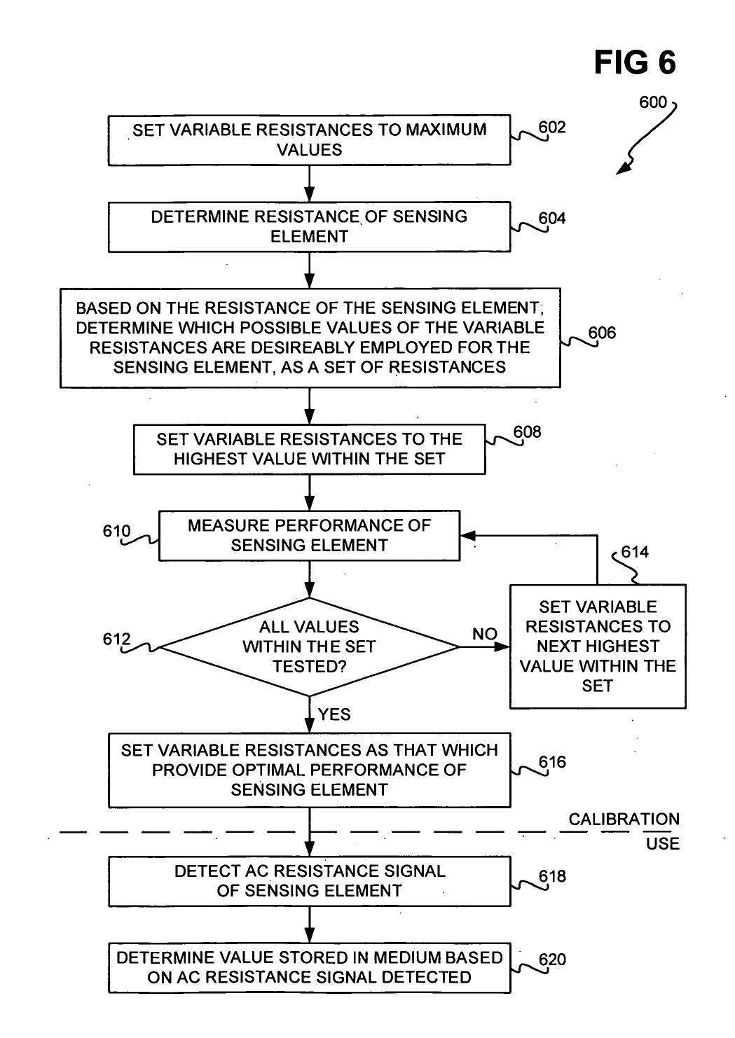

FIG. 6 shows a method 600, according to an embodiment of the invention. The method 600 is described in relation to the sensing element 102A of the sensing mechanism 100 that has been described, but is applicable to all the sensing elements 102. The method 600 is divided into two sections. Parts 602, 604, 606, 608, 610, 612, 614, and 616 relate to the calibration of the sensing element 102A, and more specifically, to how to set the variable resistances of the variable resistive elements 104A and 106A so that they are optimal for the particular sensing element 102A. By comparison, parts 618 and 620 relate to the use of the sensing element 102A, and more specifically, to how the sensing element 102A is used to read the data stored on a magnetic storage medium, after the element 102A has been configured.

It is noted that throughout the discussion of the method 600 of FIG. 6, the resistance of the variable resistive element 104A is always set equal to that of the variable resistive element 106A. First, then, the variable resistances of the variable resistive elements 104A and 106A are set to their maximum values (602). For example, consider the embodiment where each of the elements 104A and 106A includes N resistors that can be switchably connected to one another in parallel, as has been described in relation to FIG. 4 above. The highest variable resistance of each of the variable resistive elements 104A and 106A is thus:

Rᵥᵣ=Rₓ (6)

In equation (6), Rₓ is the largest resistance of any of the N resistors, where just the resistor having this resistance Rₓ is switched on, such that none of the other resistors are switched on and such that none of the other resistors contribute to the resistance Rᵥᵣ. The resistance of the sensing element 102A is then determined (604), by using any of a number of different conventional approaches. For instance, Kirkov's laws may be employed, as can be appreciated by those of ordinary skill within the art.

Thereafter, based on the resistance of the sensing element 102A, it is determined which of the possible values of the variable resistances may be desirably employed, as a set of resistances (606). That is, for the sensing element to optimally function, it may be known that a desired range of currents should flow through the sensing element 102A. This desired range of currents may be based on, among other things, the sensor amplitude, proper signal time response, reliability for thermal and electrical degradation, and minimization of the bit error rate (BER). Therefore, since the current flowing through the sensor is the voltage provided by the voltage supply 108, divided by the resistance of the sensing element in series with the variable resistances of the variable resistive elements 104A and 106A, a set of resistances that the variable resistive elements 104A and 106A may take on to yield currents within the desired range can be determined.

For example, each of the variable resistive elements 104A and 106A in FIG. 4 may include up to four resistors 402 and 406 of FIG. 4 connected in parallel to one another. The corresponding switches 404 and 408 of FIG. 4 may thus be selectively turned on or off in different combinations to differently electrically connect corresponding of the resistors 402 and 406. Thus, where there are four such switches S1, S2, S3 and S4, for each of the elements 104A and 106A, then there are fifteen different possible settings of these switches: (S1, S2, S3, S4)=(1,0,0,0), (0,1,0,0), (0,0,1,0), (0,0,0,1), (1,1,0,0), (1,0,1,0), (1,0,0,1), (0,1,1,0), (0,1,0,1), (0,0,1,1), (1,1,1,0), (1,1,0,1), (1,0,1,1), (0,1,1,1) and (1,1,1,1).

As a result, there are up to fifteen different possible combinations of the corresponding four resistors, depending on which of the resistors are switched on, and there are thus up to fifteen possible different variable resistances for each of the variable resistive elements 104A and 106A. Of these possible different variable resistances, however, only a smaller (or at least no greater) number may yield the current flowing through the sensing element 102A that is within the optimal range of currents. These resistances thus form the set of variable resistances determined in part 606.

The variable resistances of the variable resistive elements 104A and 106A are next first each set to the highest value within this set of resistances (608). That is, the individual resistors of the elements 104A and 106A are appropriately turned on or off to yield this highest resistance value. The performance of the sensing element 102A is then determined (610), by, for instance, measuring the response of the sensing element 102A to predetermined calibration data written on the magnetic tape media. If all the values within the set of resistances have not yet been tested in this way (612), then the variable resistances of the variable resistive elements 104A and 106A are each set to the next highest value within this set of resistances (614), and the method 600 is repeated at part 610. This process continues until all of the resistance values within the set of resistances have been tested.

The performance of the sensing element 102A will be best, or most optimal, where the variable resistances of the variable resistive elements 104A and 106A have been each set to an optimal given one of the values within the set of resistances. For instance, the response of the sensing element 102A to the predetermined calibration data written on the magnetic tape media may be most sensitive to the predetermined calibration data where the variable resistances of the variable resistive elements 104A and 106A were each set to a particular value within the set of resistances. Therefore, the resistance to which each of the variable resistive elements 104A and 106A is ultimately set as part of the calibration process is that within the set of resistances that provides such optimal performance of the sensing element 102A (616).

Once calibration of the sensing element 102A has been achieved, such that the optimum variable resistance values for the elements 104A and 106A have been set, the read/write head (of which the sensing element 102A is a part) may be ready for normal operation such that magnetic storage medium can be read. The magnetic storage medium is read by detecting an alternating current (AC) resistance signal of the sensing element for a given current portion of the medium (618), and, on the basis of the signal read, determining the data stored in the current portion of the medium (620).

As a simple example, where the AC resistance signal does not change, then the data is determined as a logic zero, and where there is a transition within the AC resistance signal, then the data is determined as a logic one. In actual practice, reading the magnetic storage medium is more complicated, but is well known to those of ordinary skill within the art. Because the mid-point voltages 112 of the sensing elements 102 are equal to one another, even though the currents 110 flowing through the sensing elements 102 are independently varied and may not be equal to one another, electrochemical-plating and other effects are substantially reduced, if not totally eliminated.

### ADVANTAGES AND CONCLUSION

Embodiments of the invention provide for advantages over the prior art. Within the prior art, the mid-point voltages of the sensing elements of a sensing mechanism for reading a magnetic storage medium relative to one another and to the surrounding materials at the air-bearing surface (ABS) and the medium itself can vary, causing electrochemical-plating effects, and other electrochemical effects. By comparison, in the claimed invention, these mid-point voltages, particularly the mid-point voltages 112 of the sensing elements 102, are made to be equal to one another. Other conductive materials at the ABS can also be set to the same electrical potential as the mid-points of the elements, or at some fixed value relative to the mid-point voltage of the elements, in a similar manner as has been described in relation to the sensing elements themselves. However, fixed rather than variable resistors may be used, and the resistance values may be much larger, on the order of one-thousand to ten-million ohms. As such, electrochemical-plating effects, and other electrochemical effects, are substantially reduced or eliminated. However, the currents 110 flowing through the sensing elements 102 are nevertheless independently variable via the present invention, so that optimal sensing of the magnetic storage medium by the sensing elements 102 can still be achieved.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A sensing mechanism for reading a magnetic storage medium, comprising:
a plurality of first variable resistive elements, each first variable resistive element having a variable resistance;
a plurality of second variable resistive elements, each second variable resistive element having a variable resistance; and,
a plurality of sensing elements, each sensing element having a resistance depending at least on a portion of the magnetic storage medium currently being read, a first end electrically connected to a corresponding first variable resistive element, and a second end electrically connected to a corresponding second variable resistive element,
wherein, for each sensing element, the variable resistance of the first variable resistive element to which the sensing element is electrically connected is equal to the variable resistance of the second variable resistive element to which the sensing element is electrically connected, such that a mid-point voltage at each sensing element is equal,
and wherein, for each sensing element, the variable resistances of the first and second variable resistive elements to which the sensing element is electrically connected are selected so that a desired current flows through the sensing element.

2. The sensing mechanism of claim 1, wherein the current flowing through each sensing element is independent of the current flowing through each other of the sensing elements, even though the mid-point voltage at each sensing element is equal.

3. The sensing mechanism of claim 1, wherein the current flowing through each sensing element is based at least on the resistance of the sensing element, the variable resistance of the corresponding first variable resistive element, and the variable resistance of the corresponding second variable resistive element.

4. The sensing mechanism of claim 1, wherein the mid-point voltage at each sensing element being equal substantially reduces a potential that interaction between the sensing mechanism and the magnetic storage medium causes electrochemical-plating effects on the sensing elements.

5. The sensing mechanism of claim 1, wherein the mid-point voltage at each sensing element is a voltage measurable halfway-between the first end and the second end of the sensing element.

6. The sensing mechanism of claim 1, wherein, for each sensing element, a same voltage source is electrically connected across a series connection of the first variable resistive element, the sensing element, and the second variable resistive element, such that the mid-point voltage at each sensing element is equal to a voltage provided by the voltage source divided by two.

7. The sensing mechanism of claim 6, further comprising the voltage source.

8. The sensing mechanism of claim 1, further comprising:
a plurality of first constant resistive elements, each first constant resistive element having a constant resistance and electrically connected to a sensing element and to a corresponding first variable resistive element; and,
a plurality of second constant resistive elements, each second constant resistive element having a constant resistance and electrically connected to a sensing element and to a corresponding second variable resistive element,
wherein, for each sensing element, the constant resistance of the first constant resistive element to which the sensing element is electrically connected is equal to the constant resistance of the second constant resistive element to which the sensing element is electrically connected.

9. The sensing mechanism of claim 1, wherein each of the first and second variable resistive elements comprises:
a plurality of resistors organized in parallel to one another; and,
a plurality of switches, each switch having an on position in which a corresponding resistor is electrically connected to a sensing element, and an off position in which the corresponding resistor is electrically disconnected from the sensing element,
wherein the switches are selectively turned on and off so that the desired current flows through the sensing element.

10. A sensing mechanism for reading a magnetic storage medium, comprising:
a plurality of sensing elements, each sensing element having a resistance depending at least on a portion of the magnetic storage medium currently being read, a first end, and a second end; and,
means for selectively varying a current flowing through each sensing element, while maintaining an equal mid-point voltage at each sensing element.

11. The sensing mechanism of claim 10, wherein the means comprises, for each sensing element:
a plurality of first variable resistive elements, each first variable resistive element having a variable resistance; and,
a plurality of second variable resistive elements, each second variable resistive element having a variable resistance,
wherein the variable resistance of the first variable resistive element is equal to the variable resistance of the second variable resistive element.

12. The sensing mechanism of claim 10, wherein the mid-point voltage at each sensing element is a voltage measurable halfway-between the first end and the second end of the sensing element.

13. A storage device comprising:
one or more motors to move a magnetic storage medium; and,
a sensing mechanism to read the magnetic storage medium as the magnetic storage medium is moved, the sensing mechanism comprising:
a plurality of sensing elements, each sensing element having a resistance depending at least on a portion of the magnetic storage medium currently being read, a first end, and a second end; and,
a plurality of variable resistive mechanisms, each variable resistive mechanism electrically connected to the first and second ends of a corresponding sensing element to selectively vary a current flowing through the corresponding sensing element, while maintaining a mid-point voltage at the sensing element equal to a mid-point voltage at each other sensing element.

14. The storage device of claim 13, wherein each variable resistive mechanism comprises:
a first constant resistive element having a constant resistance and electrically connected to the first end of a corresponding sensing element;
a second constant resistive element having the constant resistance and electrically connected to the second end of the corresponding sensing element;
a first variable resistive element having a variable resistance and electrically connected to the first constant resistive element; and,
a second variable resistive element having a variable resistance and electrically connected to the second constant resistive element,
wherein the variable resistance of the first variable resistive element is equal to the variable resistance of the second variable resistive element, such that the mid-point voltage remains constant despite variation of the current flowing through the corresponding sensing element.

15. The storage device of claim 14, wherein each first variable resistive element and each second variable resistive element comprises:
a plurality of resistors organized in parallel to one another; and,
a plurality of switches, each switch having an on position in which a corresponding resistor is electrically connected to a sensing element, and an off position in which the corresponding resistor is electrically disconnected from the sensing element,
wherein the switches are selectively turned on and off to vary the current flowing through the sensing element.

16. The storage device of claim 14, further comprising the magnetic storage medium, such that the magnetic storage medium is fixed within the mass storage device.

17. The storage device of claim 14, wherein the magnetic storage medium is removably insertable into the mass storage device.

18. A method comprising:
setting a variable resistance of a first variable resistive element electrically connected to a first end of a sensing element of a sensing mechanism for reading a magnetic storage medium;
setting a variable resistance of a second variable resistive element electrically connected to a second end of the sensing element of the sensing mechanism equal to the variable resistance of the first variable resistive element to maintain a constant mid-point voltage at the sensing element;
detecting an alternating current (AC) resistance signal of the sensing element; and,
determining a value stored in the magnetic storage medium based on the AC resistance signal of the sensing element detected.

19. The method of claim 18, wherein setting the variable resistance of the first variable resistive element comprises selectively turning on one or more switches of the first variable resistive element to electrically connect one or more corresponding resistors of the first variable resistive element to the sensing element.

20. The method of claim 19, wherein setting the variable resistance of the second variable resistive element comprises selectively turning on one or more switches of the second variable resistive element to electrically connect one or more corresponding resistors of the second variable resistive element to the sensing element.
